(19) United States
(12) Patent Application Publication
(10) Pub. No.: US 2026/0370331 A1
(43) Pub. Date: Nov. 19, 2026

(54) SINGLE-FIBER BIDIRECTIONAL OPTICAL TRANSCEIVER MODULE

(71) Applicant: InnoLight Technology (Suzhou) Ltd., Suzhou, Jiangsu (CN)

(72) Inventors: Jian Zhou, Suzhou, Jiangsu (CN); Yan Zhou, Suzhou, Jiangsu (CN)

(21) Appl. No.: 18/995,987

(22) PCT Filed: Jun. 16, 2023
(86) PCT No.: PCT/CN2023/100650

§ 371 Date: Jan. 17, 2025

(30) Foreign Application Priority Data
Aug. 10, 2022 (CN) 202210958745.3

(51) Int. Cl. H04B 10/25; H04B 10/40

(52) U.S. Cl. CPC H04B 10/2589; H04B 10/40

(57) ABSTRACT

A single-fiber bidirectional optical transceiver module (100). An optical port (60), a circulator assembly (30) and an optical receiving assembly (20) inside the single-fiber bidirectional optical transceiver module are sequentially arranged from left to right, wherein at least part of the structure of an optical transmitting assembly (10) is arranged in the left front of the optical receiving assembly (20). The single-fiber bidirectional optical transceiver module (100) further comprises an optical guide assembly (40), wherein at least part of the structure of the circulator assembly (30) is arranged at the right rear of at least part of the structure of the optical guide assembly (40); the optical transmitting assembly (10) transmits transmitted light to the left; the optical guide assembly (40) is used for guiding the transmitted light to enter the circulator assembly (30); and the transmitted light is propagated to the right rear during at least part of the process of propagating the transmitted light by the optical guide assembly (40). By means of redesigning the structure of the single-fiber bidirectional optical transceiver module (100) and a positional relationship between internal structures, the space utilization rates of the positions of the optical transmitting assembly (10) and the optical receiving assembly (20) are improved, such that a circuit board can be longer and can integrate more components, thereby improving the integration degree of the single-fiber bidirectional optical transceiver module (100).

### CROSS-REFERENCE TO RELATED PATENT APPLICATION

The present disclosure claims priority to the Chinese patent application filed with the China Patent Office on Aug. 10, 2022, with the application number 202210958745.3 and the invention name “SINGLE-FIBER BIDIRECTIONAL OPTICAL TRANSCEIVER MODULE”, the entire content of which is incorporated into the present disclosure by reference.

### FIELD OF THE DISCLOSURE

The present disclosure relates to the technical field of optical fiber communication, and in particular to a single-fiber bidirectional optical transceiver module.

### BACKGROUND TECHNIQUE

The single-fiber bidirectional optical transceiver module enables bidirectional transmission within a single optical fiber, separating forward and reverse optical signal transmissions and facilitating both transmission and reception of optical signals. It is a critical component of an optical module. The single-fiber bidirectional optical transceiver module comprises substantially rectangular parallelepiped housing, an optical transmitting component, and an optical receiving component accommodated within the housing. A commonly used single-fiber bidirectional optical transceiver module includes housing, an optical transmitting component and an optical receiving component housed within the housing, and a circuit board. The optical transmitting component and the optical receiving component, as shown in FIG. 1, includes an optical transmitting component 10 and an optical receiving component 30 arranged side by side. Since the optical transmitting component 10 incorporates a laser component 12, it contains more components than the optical receiving component 30, resulting in a longer length for the optical transmitting component and the optical receiving component. This design, on the one hand, leads to inefficient use of space within the optical transmitting and receiving component, thus limiting the size of the circuit board. On the other hand, it hinders the integration level of single-fiber bidirectional optical transceiver modules.

### SUMMARY OF THE DISCLOSURE

In order to solve the problems in the prior art, the purpose of the present disclosure is to provide a single-fiber bidirectional optical transceiver module with a higher integration level.

In order to achieve the above object, one embodiment of the present disclosure provides a single-fiber bidirectional optical transceiver module, including a carrier board, and an optical port, an optical transmitting component, an optical receiving component and a circulator component fixed on the carrier board, wherein the optical port, the circulator component, the optical receiving component are arranged sequentially from left to right, characterized in that the optical transmitting component is arranged in parallel with the circulator component and the optical receiving component in the front-rear direction, with at least a portion of a structure positioned to a left-front of the optical receiving component, the single-fiber bidirectional optical transceiver module further includes an optical guide component, a part of the optical guide component is located to a left of the optical transmitting component and a part of the optical guide component is between the optical transmitting component and the circulator component; and an emitted light emitted to a left by the optical transmitting component is directed into the circulator component via the optical guide component, and during at least part of a propagation process through the optical guide component, the emitted light propagates in a right-rearward direction.

As a further improvement of the present disclosure, the optical guide component includes a reflective prism that guides the emitted light emitted by the optical transmitting component to the circulator component through reflection.

As a further improvement of the present disclosure, the reflective prism includes a first reflective prism and a second reflective prism; the first reflective prism is disposed on a left side of the optical transmitting component, and a second transmitting prism is disposed in front of the circulator component; the first reflecting prism reflects the emitted light emitted by the optical transmitting component to the second reflecting prism, and the second reflecting prism reflects a reflected light received from the first reflective prism into an optical circulator component.

As a further improvement of the present disclosure, the first reflective prism includes:
a first reflective film surface and a second reflective film surface;
the second reflective prism is disposed at a right rear of the first reflective prism, and the second reflective prism includes a third reflective film surface; and
the emitted light emitted from the optical transmitting component is sequentially reflected by the first reflective film surface and the second reflective film surface, then emitted to the second reflective prism, and the emitted light is emitted into circulator component after being reflected by the third reflective film.

As a further improvement of the present disclosure, the circulator component includes a fourth reflective film surface, and the emitted light is reflected to the fourth reflective film surface through the third reflective film surface, then is emitted to a left after being reflected by the fourth reflective film surface.

As a further improvement of the present disclosure, the first reflective film surface and the third reflective film surface are arranged parallel to each other, and the second reflective film surface and the fourth reflective film surface are arranged parallel to each other.

As a further improvement of the present disclosure, an included angle between the first reflective film surface and the second reflective film surface is 90°, and an included angle between the third reflective film surface and the fourth reflective film surfaces is 90°.

As a further improvement of the present disclosure, the circulator component further includes a circulator, an incident prism, and a prism group, wherein the emitted light reflected from the second reflective prism sequentially passes through the incident prism, the circulator, and the prism group, and then enters the optical port;

an incident light emitted from the optical port sequentially passes through the prism group, the circulator, and the incident prism, and then enters the optical receiving assembly.

As a further improvement of the present disclosure, in a left-right direction, the circulator is arranged parallel to a part of a structure of the optical transmitting component.

As a further improvement of the present disclosure, the second reflective prism includes the third reflective film surface, and the incident prism includes the fourth reflective film surface, wherein a first beam-splitting film is arranged between the second reflective prism and the incident prism, and the second reflective prism and the incident prism are arranged to abut on both sides of the first beam-splitting film;
the emitted light is reflected by the third reflective film surface, passes through the first beam-splitting film, then is reflected by the fourth reflective film surface and exits to a left; and
a horizontally polarized incident light in the incident light passes through the first beam-splitting film and exits to a right, while a vertically polarized incident light in the incident light is reflected by the fourth reflective film surface, then is reflected by the first beam-splitting film, and exits to a right.

As a further improvement of the present disclosure, the optical guide component further includes an isolator and a first half-wave plate, wherein the first reflective prism, the first half-wave plate, the isolator, and the optical transmitting component are sequentially arranged from left to right.

As a further improvement of the present disclosure, the optical transmitting component includes a wavelength division multiplexer, the optical receiving component includes a wavelength demultiplexer and a photodetector, the wavelength division multiplexer is arranged on a left front of the wave demultiplexer, and the photodetector is arranged at a right of the wave demultiplexer.

As a further improvement of the present disclosure, the optical transmitting component further includes a laser component, and the laser component includes a substrate disposed on the carrier board, and a plurality of lasers and a collimating lens disposed on the substrate;
the laser component is arranged at a right of the wavelength division multiplexer, and a light emitted by the laser enters the wavelength division multiplexer through the collimating lens; and
a rightmost end of the laser component is aligned with a rightmost end of the wavelength demultiplexer in a left-right direction.

As a further improvement of the present disclosure, the single-fiber bidirectional optical transceiver module further includes a circuit board fixed on the carrier board, and the circuit board is disposed on a right side of the optical transmitting component and the optical receiving component.

Compared with conventional technology, the present disclosure offers the following beneficial effects: by redesigning the structure of the single-fiber bidirectional optical transceiver module and optimizing the positional relationship of its internal components, the space utilization of the optical transmitting component and the optical receiving component is significantly enhanced. This improvement allows for a longer circuit board capable of integrating more components, thereby increasing the integration level of single-fiber bidirectional optical transceiver modules.

### BRIEF DESCRIPTION OF THE DRAWINGS

FIG. 1 is a schematic diagram of part of the structure of a commonly used single-fiber bidirectional optical transceiver module;

FIG. 2 is a schematic structural diagram of a partial structure of a single-fiber bidirectional optical transceiver module according to an embodiment of the present disclosure;

FIG. 3 is another structural schematic diagram of a partial structure of a single-fiber bidirectional optical transceiver module according to an embodiment of the present disclosure;

FIG. 4 is a schematic diagram of the emission optical path of the circulator component and the optical guide assembly according to an embodiment of the present disclosure;

FIG. 5 is a schematic diagram of the emission optical path of the circulator component and the optical guide assembly according to another embodiment of the present disclosure;

FIG. 6 is a schematic diagram of the emission optical path of the circulator component and the optical guide assembly according to yet another embodiment of the present disclosure;

FIG. 7 is a schematic diagram of the receiving optical path of the circulator component and the optical guide assembly according to an embodiment of the present disclosure;

Among them, 100. Single-fiber bidirectional optical transceiver module; 10. Optical transmitting component; 11. Wavelength division multiplexer; 12. Laser component; 121. Laser; 122. Collimating lens; 123. Substrate; 20. Optical receiving component; 21. Wave demultiplexer; 30. Circulator component; 31. Incident prism; 311. Fourth reflective film surface; 32. Circulator; 321. Faraday rotator; 322. Second half-wave plate; 33. Prism group; 331. Translation prism; 332. First prism; 333. Second light splitting film; 334. Second prism; 40. Optical guide component; 41. First reflective prism; 411. First reflective film surface; 412. Second Reflective film surface; 42. Second reflective prism; 421. Third reflective film surface; 422. First light splitting film; 43. Isolator; 44. First half-wave plate; 50. Carrier board; 60. Optical port; 70, Circuit board.

### DETAILED DESCRIPTION OF THE EXEMPLARY EMBODIMENTS

The present disclosure will be described in detail below with reference to the specific embodiments shown in the accompanying drawings. However, these embodiments do not limit the present disclosure. Structural, method, or functional changes made by those of ordinary skill in the art based on these embodiments are all included in the protection scope of the present disclosure.

It should be understood that terms such as “on,” “above,” “down,” “below,” and similar spatial references used herein are for illustrative purposes and describe the relative positions of elements or features as depicted in the drawings. These spatial terms may also encompass different orientations of the device during use or operation, beyond the orientation shown in the figures.

An embodiment of the present disclosure provides a single-fiber bidirectional optical transceiver module 100 that can achieve a higher integration level, which includes a housing, an optical transmitting component and an optical receiving component accommodated in the housing, and a circuit board 70. The optical transmitting component and the receiving component are shown in FIG. 2, which includes a carrier board 50, an optical port 60 on the carrier board 50, an optical transmitting component 10, an optical receiving component 20, a circulator component 30 and an optical guide component 40.

The single-fiber bidirectional optical transceiver module 100 has a roughly rectangular parallelepiped structure. An optical port 60 is provided at one end of the length direction of the cuboid, and an electrical port is provided at the other end. The optical port 60 is used to connect optical signal information transmission equipment such as optical fibers or optical waveguides, and the electrical port is used to connect to information processing equipment such as optical network terminals (such as optical modems) or computers. The single-fiber bidirectional optical transceiver module 100 realizes conversion of optical signals into electrical signals, and/or conversion of electrical signals into optical signals.

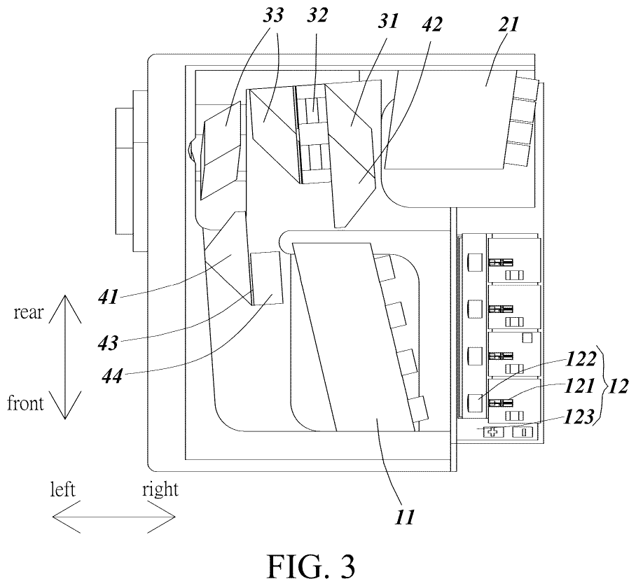

To clearly express the position and direction described in this embodiment, the left and right directions are defined based on the length direction of the cuboid-shaped single-fiber bidirectional optical transceiver module 100. In this embodiment, the optical port 60 is positioned at the far-left end of the single-fiber bidirectional optical transceiver module 100, with the opposite direction defined as the right. On a plane perpendicular to the left and right directions, the optical transmitting component 10 is located in front of the optical receiving component 20. The definitions of the left, right, front, and rear directions can also be referenced in combination with the partial structure of the single-fiber bidirectional optical transceiver module 100 shown in FIG. 3. Furthermore, on the plane perpendicular to the front-rear and left-right directions, the upper and lower sides are defined accordingly.

Furthermore, in this embodiment, when a certain component is located on the left side in another direction, the component and another component may be staggered relative to each other in the front-rear direction or the up-down direction. For instance, when the optical transmitting component 10 is positioned in front of the optical receiving component 20, at least part of the structure of the optical transmitting component 10 may be located to the left of the optical receiving component 20.

The optical port 60, the circulator component 30, and the optical receiving assembly 20 are arranged sequentially from left to right. The optical transmitting component 10 is positioned side by side with the circulator component 30 and the optical receiving assembly 20 in the front-to-back direction. Specifically, the optical port 60, the circulator component 30, and the optical receiving assembly 20 may be staggered relative to each other in the front-to-back direction, while the optical transmitting component 10, the circulator component 30, and the optical receiving assembly 20 may be staggered relative to each other in the left-to-right direction.

At least part of the structure of the optical transmitting component 10 is positioned at the left front of the optical receiving component 20. The single-fiber bidirectional optical transceiver module 100 also includes an optical guide component 40. At least part of the structure of the circulator component 30 is positioned on the right side and rear of at least part of the structure of the optical guide component 40. Specifically, the optical guide component 40 is partially positioned on the left side of the optical transmitting component 10 and partially positioned between the optical transmitting component 10 and the circulator component 30. In other words, part of the structure of the optical guide component 40 is positioned on the left side of the optical transmitting component 10, while another part is positioned behind the optical transmitting component 10.

The optical transmitting component 10 emits light to the left. The optical guide component 40 is configured to guide the emitted light into the circulator component 30. During at least part of the propagation process through the optical guide component 40, the emitted light propagates toward the right rear.

In this embodiment, the optical guide component 40 includes a reflective prism, which is used to guide the emitted light from the optical transmitting component 10 to the circulator component 30 through reflection.

The reflective prism comprises a first reflective prism 41 and a second reflective prism 42. The first reflective prism 41 is positioned on the left of the optical transmitting component 10, while the second reflective prism 42 is positioned in front of the circulator component 30. The first reflective prism 41 reflects the emitted light from the optical transmitting component 10 to the second reflective prism 42. The second reflective prism 42 then reflects the light received from the first reflective prism 41 into the circulator component 30. Here, the phrase “the second reflective prism 42 is positioned in front of the circulator component 30” indicates that at least part of the second reflective prism 42 is located in front of the entire circulator component 30. The specific configuration is illustrated in FIG. 3.

The first reflective prism 41 includes a first reflective film surface 411 and a second reflective film surface 412. The first reflective prism 41 group 33 is disposed on the left front of the second reflective prism 42, and the second reflective prism 42 includes a third reflective film surface 421 as shown in FIG. 3.

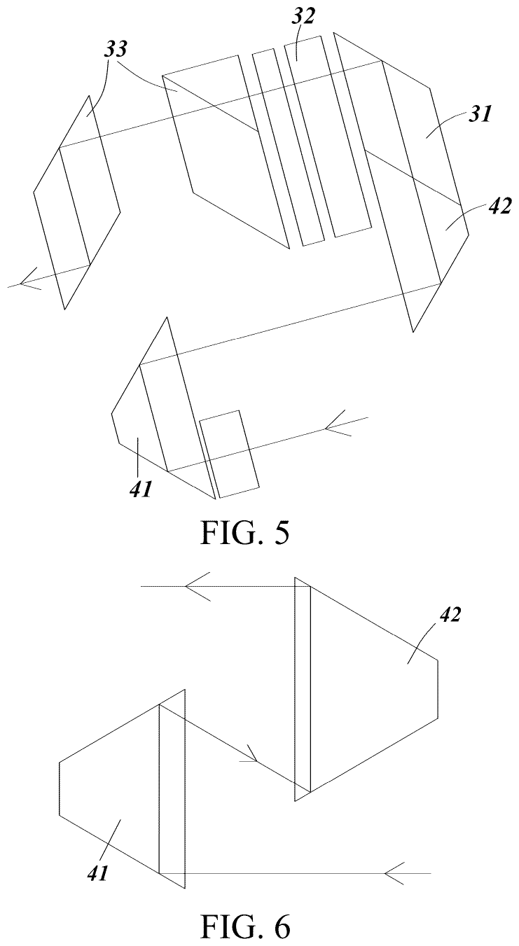

The optical guide component 40 receives the emitted light emitted to the left from the optical transmitting component 10. After being reflected by the first reflective film surface 411 and the second reflective film surface 412, the emitted light is directed to the second reflective prism 42. The emitted light is then sequentially reflected by the third reflective film surface 421 and then is emitted. The leftward emission here may have a leftward component. For example, in FIGS. 3 and 5, the emitted light is not emitted in the horizontal direction, but is emitted toward the left front to the first reflective prism 41.

In addition, in other embodiments, the reflective prism can include more prisms with reflective functions, which can guide the emitted light to the right rear, or the optical guide assembly 40 can be a plurality of optical fibers to guide the emitted light to the circulator component 30 on the right rear.

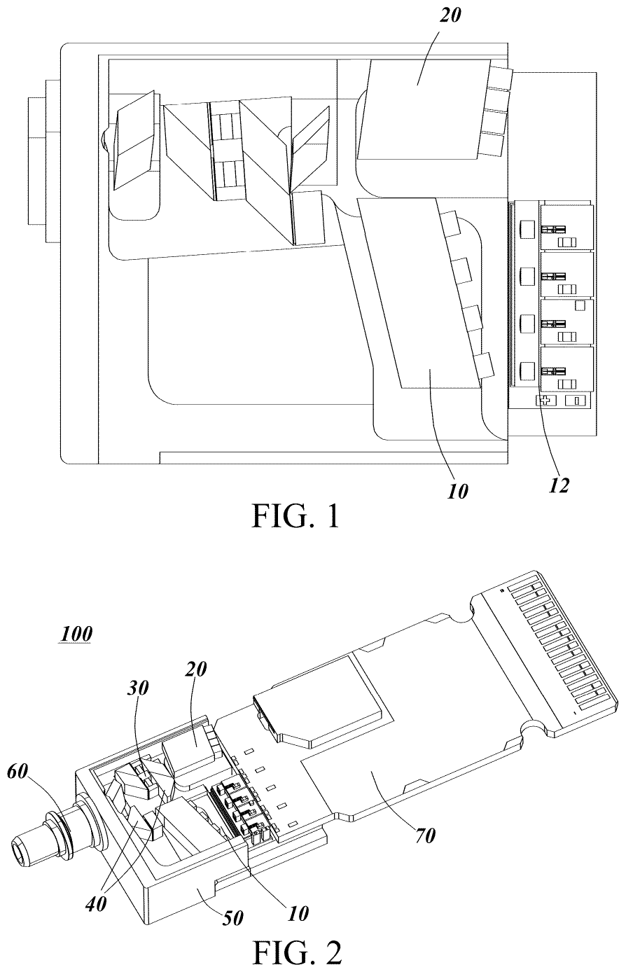

Since the emitted light from the optical transmitting component 10 is first directed to the left, it is reflected by the first reflective prism 41 to the second reflective prism 42 located at the rear right, and then continues to propagate to the left through the circulator component 30. This design eliminates the need for the optical transmitting component 10 to be positioned on the right side of the circulator component 30. Instead, the optical transmitting component 10 can be positioned on the left front side of the circulator component 30. In conventional technology, as described in the background section and shown in FIG. 1, both the optical transmitting component 10 and the optical receiving component 20 are typically positioned on the right side of the circulator component 30. Moreover, the optical transmitting component 10 generally includes more components than the optical receiving component 20, resulting in the optical transmitting component 10 occupying a longer space on the right side of the circulator component 30. Consequently, this arrangement causes the optical transmitting component 10 to take up significant space in the left-right direction. In this embodiment, as shown in FIG. 3, at least part of the structure of the optical transmitting component 10 is moved to the left front of the optical receiving component 20 in the left-right direction to utilize the space in front of the circulator component 30, which reduces the space occupied on the right side of the circulator component 30, thereby improving the overall space utilization within the single-fiber bidirectional optical transceiver module 100.

Further, the optical transmitting component 10 includes a wavelength division multiplexer 11, while the optical receiving component 20 includes a wavelength demultiplexer 21 and a photodetector. Additionally, the optical transmitting component 10 comprises a laser component 12. The laser component 12 includes a substrate 123 positioned on the carrier 50, as well as a plurality of lasers 121 and collimating lenses 122 arranged on the substrate 123. The photodetector is positioned to the right of the wavelength demultiplexer 21. Taking FIG. 3 as an example, the plurality of lasers 121 are paired with corresponding collimating lens 122. Optical signals of four different wavelengths emitted by the plurality of lasers 121 pass through the respective collimating lenses 122, where they are collimated into parallel beams. These beams are then multiplexed by the wavelength division multiplexer 11, pass through the circulator component 30, and are transmitted to the optical port 60 for output. Conversely, optical signals containing four different wavelengths received from the optical port 60 pass through the circulator component 30, are demultiplexed by the wavelength demultiplexer 21 into separate beams, and are subsequently received by downstream structures such as photodiode arrays.

In FIG. 3, the wavelength division multiplexer 11 is positioned at the left front of the wavelength demultiplexer 21. Here, “left front” indicates that the leftmost end of the wavelength division multiplexer 11 is situated to the left of the leftmost end of the wavelength demultiplexer 21. Furthermore, the wavelength division multiplexer 11 is located in front of the wavelength demultiplexer 21. While certain structures of the wavelength demultiplexer 21 are entirely on the left side of the leftmost end of the wavelength demultiplexer 21, this does not preclude the possibility of the wavelength demultiplexer 21 having some structures extending to the right side of its leftmost end.

In addition, in the left-right direction, the rightmost end of the carrier board 50 is aligned with the rightmost end of the wavelength demultiplexer 21. As shown in FIG. 3, “aligned” means that the rightmost end of the carrier board 50 and the rightmost end of the wavelength demultiplexer 21 are positioned on the same front, rear, up, and down plane. This alignment does not preclude slight deviations in the left-right direction. For instance, the carrier board 50 may extend slightly further to the right, or the wavelength demultiplexer 21 may extend slightly further to the right. However, such deviations are minor relative to the overall size of the carrier board 50 or the wavelength demultiplexer 21. Therefore, these slight differences are negligible, and the rightmost end of the carrier board 50 can be considered aligned with the rightmost end of the wavelength demultiplexer 21.

Further, the optical guide assembly 40 further includes an isolator 43 and a first half-wave plate 44. The isolator 43 is disposed between the first reflective prism 41 and the wavelength division multiplexer 11. The isolator 43 not only prevents the emitted light from returning into the optical transmitting component 10 but also prevents the received light from entering the optical transmitting component 10. Due to the presence of the isolator 43, the received light cannot enter the optical transmitting component 10, thus avoiding optical crosstalk in the optical transmitting component 10. The first half-wave plate 44 can offset the change in the polarization direction of the emitted light that may be caused by the isolator 43.

The first reflective prism 41, the first half-wave plate 44, the isolator 43 and the wavelength division multiplexer 11 are arranged in sequence from left to right.

Further, the circulator component 30 includes a fourth reflective film surface 311. The emitted light is reflected to the fourth reflective film surface 311 through the third reflective film surface 421, and then is reflected by the fourth reflective film surface 311 and then emitted to the left.

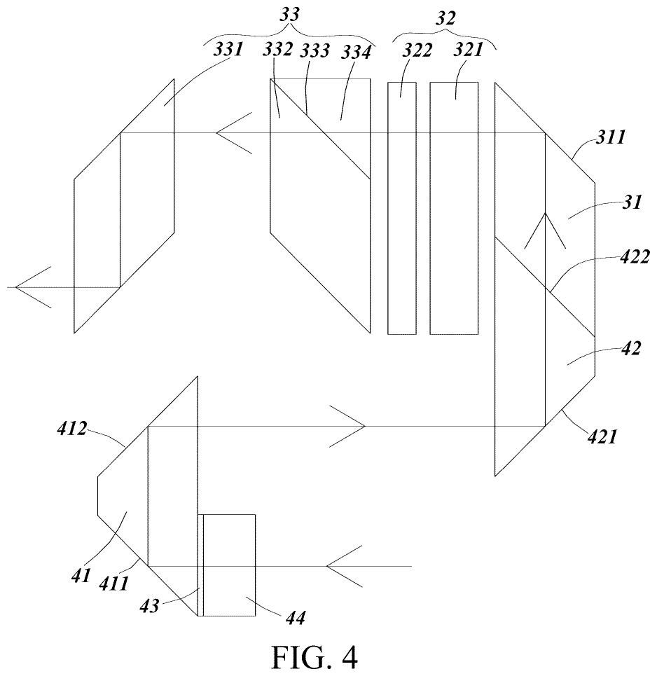

Referring to FIGS. 3, 4, 5 and 7, the included angle between the first reflective film surface 411 and the second reflective film surface 412 is 90°, and the included angle between the third reflective film surface 421 and the fourth reflective film surface 311 is 90°. In this way, the emitted light incident on the first reflective prism 41 is emitted in the completely opposite direction, and the emitted light incident on the second reflective prism 42 is emitted in the completely opposite direction. For example, as shown in FIG. 4, the emitted light entering the first reflective prism 41 from the right is reflected by the first reflective film surface 411 and redirected to the left. It then passes through the second reflective prism 42 and is ultimately reflected by the fourth reflective film surface 311, being directed straight to the left.

The circulator component 30 and the optical guide assembly 40 of this embodiment can be shown in FIG. 4. The first reflective film surface 411, the second reflective film surface 412, the third reflective film surface 421 and the fourth reflective film surface 311 are all at an angle of 90° to the left and right directions. The transmission direction of the emitted light is completely towards the right left, right, front or rear.

Alternatively, as shown in FIGS. 3 and 5, both the first reflective prism 41 and the second reflective prism 42 are tilted at specific angles. As a result, the emitted light is transmitted at an inclined angle within the first reflective prism 41 and the second reflective prism 42.

As shown in FIG. 6, the included angle between the first reflective film surface 411 and the second reflective film surface 412, and the included angle between the third reflective film surface 421 and the fourth reflective film surface 311 may not be 90°. For example, they may be 60°. The light can also be transmitted to the left first, and after being reflected by the first reflective prism 41, it has a rightward component, and then is transmitted to the left after passing through the second reflective prism 42 and the fourth reflective film surface 311.

In addition, the first reflective film surface 411 and the third reflective film surface 421 are arranged in parallel, and the second reflective film surface 412 and the fourth reflective film surface 311 are arranged in parallel, as shown in FIGS. 3 to 7, so that the light emitted from the optical transmitting component 10 is parallel to the emitted light emitted from the fourth reflective film surface 311.

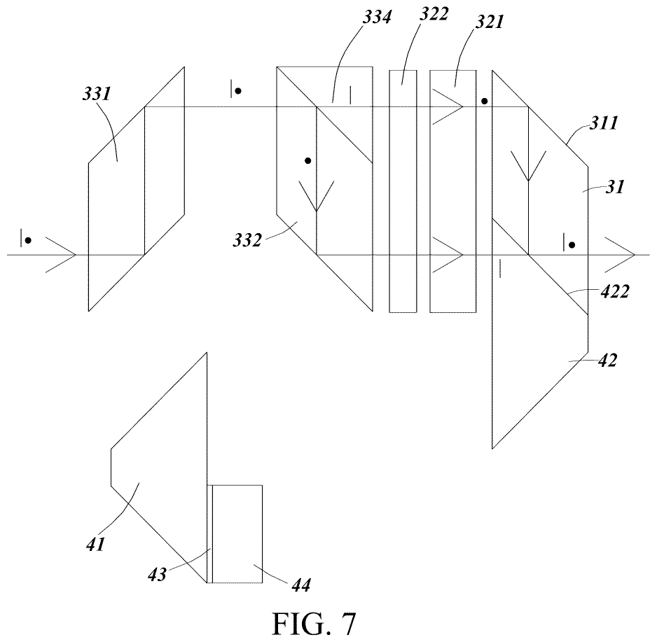

Further, the circulator component 30 also includes an incident prism 31, a circulator 32, and a prism group 33. As shown in FIG. 4 or FIG. 7, the emitted light emitted from the incident prism 31 passes through the circulator 32 and the prism group 33 in sequence, and then is emitted into the optical port 60.

The incident light emitted from the optical port 60 passes through the prism group 33, the circulator 32 and the incident prism 31 in sequence, and then enters the optical receiving component 20.

FIG. 3 shows the transmitting optical path transmission path of the emitted light emitted through the optical transmitting component 10 on the circulator component 30, and FIG. 7 shows the receiving optical path transmission path of the incident light emitted through the optical port 60 on the circulator component 30. In FIG. 7, “I” represents a parallel polarized beam, and “.” represents a vertically polarized beam. It should be understood that in the working state of the circulator component 30, the transmitting optical path and the receiving optical path may coexist at the same time.

In addition, in the left-right direction, the circulator 32 is aligned with a partial structure of the optical transmitting component 10. Furthermore, the wavelength division multiplexer 11 of the optical transmitting component 10 is aligned with the circulator 32 on the front, rear, and upper planes. Since the shapes and sizes of the wavelength division multiplexer 11 and the circulator 32 are not identical, it can be understood that part of the structure of the wavelength division multiplexer 11 is aligned with part of the circulator 32. Additionally, the wavelength division multiplexer 11 may also have structures extending to the left and/or right side of the circulator 32. The alignment of the circulator 32 with a partial structure of the optical transmitting component 10 illustrates the specific position of the optical transmitting component 10. It further indicates that at least part of the structure of the optical transmitting component 10 is disposed at the left front of the optical receiving component 20, and that at least part of the structure of the circulator component 30 is positioned at the right rear of at least part of the structure of the optical guide assembly 40.

Further, as shown in FIG. 4, the second reflective prism 42 includes a third reflective film surface 421, and the incident prism 31 includes a fourth reflective film surface 311. The polarized light beam in the parallel direction can pass through the first light splitting film 422, and the polarized light beam in the vertical direction will be reflected when passing through the first light splitting film 422.

The circulator 32 includes a second half-wave plate 322 and a Faraday rotator 321. The Faraday rotator 321 alters the polarization direction of light under the influence of a magnetic field, causing the polarization direction to rotate clockwise in the direction of light propagation and counterclockwise in the opposite direction. The second half-wave plate 322 rotates the polarization direction of the light clockwise as it passes through, regardless of whether the light is moving in the forward or reverse direction.

The prism group 33 includes a translation prism 331, a first prism 332, a second prism 334, and a second light splitting film 333 positioned between the first prism 332 and the second prism 334. The translation prism 331 adjusts the light beam to an appropriate position. Both the first prism 332 and the second prism 334 may function as polarizing beam-splitting prisms and are arranged in close proximity to each other. The second light splitting film 333 can allow the polarized light beams in the parallel direction to pass through and can reflect the polarized light beams in the vertical direction.

The first reflective film surface 411, the second reflective film surface 412, the third reflective film surface 421 and the fourth reflective film surface 311 all reflect polarized light beams in parallel and vertical directions.

The emitted light is reflected by the third reflective film surface 421, passes through the first light splitting film 422, and is further reflected by the fourth reflective film surface 311 before being emitted to the left. For the incident light, horizontally polarized light passes through the first light splitting film 422 and emitted to the right, while the vertically polarized light is first reflected by the fourth reflective film surface 311, then reflected by the first light splitting film 422, and finally emitted to the right.

The optical signal received by the optical port 60 is incident on the wavelength demultiplexer 21 of the optical receiving component 20 through the circulator component 30. The emitted light emitted by the optical transmitting component 10 is combined by its wavelength division multiplexer 11 and then is transmitted to the optical port 60 through the circulator component 30, and the optical port 60 outputs the emitted light emitted by the optical transmitting component 10. The optical transmitting component 10, the optical receiving component 20, the optical guide component 40 and the circulator component 30 are packaged in the housing. The combination of the Faraday rotator 321, the second half-wave plate 322, the first reflective prism 41, the second reflective prism 42, the incident prism 31, and the prism group 33 is used to realize the orthogonal transformation of the polarization states of the emitted light and the incident light, so that the transmitting optical path and the receiving optical path have different directions in the single-fiber bidirectional optical transceiver module 100, thereby realizing the single-fiber bidirectional function.

During the installation of the single-fiber bidirectional optical transceiver module 100, the circulator 32 can first be passively assembled and adhered to the carrier board 50 using glue. Subsequently, the first reflective prism 41 and the second reflective prism 42 can be assembled through an active assembly method. In the assembly method, the installation angle and position are adjusted, and the optical axis position and angle of the optical transmitting component 10 are effectively controlled by gluing on the carrier plate 50.

Compared with common technologies, this embodiment has the following beneficial effects.

By redesigning the structure of the single-fiber bidirectional optical transceiver module 100 and optimizing the positional relationship among its internal structures, the space utilization of the optical transmitting component 10 and the optical receiving component 20 is enhanced. This allows the circuit board 70 to be extended and accommodates more integrated components, thereby improving the overall integration level of the single-fiber bidirectional optical transceiver module 100.

It should be understood that although this specification describes specific implementations, each implementation does not necessarily contain an independent technical solution. The description in this specification is provided for the purpose of clarity. Persons skilled in the art should interpret the specification as a whole and recognize that individual solutions described herein can be appropriately combined to form other embodiments that align with the technical concepts disclosed in this specification.

The detailed descriptions provided above are specific examples of feasible implementations of the present disclosure and are not intended to limit its scope. Any equivalent implementations or modifications that do not deviate from the technical spirit of the present disclosure should be included within its protection scope. All such changes fall within the scope of protection as defined by the present disclosure.

1. A single-fiber bidirectional optical transceiver module, including a carrier board, and an optical port, an optical transmitting component, an optical receiving component and a circulator component fixed on the carrier board, wherein the optical port, the circulator component, the optical receiving component are arranged sequentially from left to right, characterized in that the optical transmitting component is arranged in parallel with the circulator component and the optical receiving component in the front-rear direction, with at least a portion of a structure positioned to a left-front of the optical receiving component, the single-fiber bidirectional optical transceiver module further includes an optical guide component, a part of the optical guide component is located to a left of the optical transmitting component and a part of the optical guide component is between the optical transmitting component and the circulator component; and
an emitted light emitted to a left by the optical transmitting component is directed into the circulator component via the optical guide component, and during at least part of a propagation process through the optical guide component, the emitted light propagates in a right-rearward direction.

2. The single-fiber bidirectional optical transceiver module according to claim 1, characterized in that, the optical guide component includes a reflective prism that guides the emitted light emitted by the optical transmitting component to the circulator component through reflection.

3. The single-fiber bidirectional optical transceiver module according to claim 2, characterized in that, the reflective prism includes a first reflective prism and a second reflective prism; the first reflective prism is disposed on a left side of the optical transmitting component, and a second transmitting prism is disposed in front of the circulator component; the first reflecting prism reflects the emitted light emitted by the optical transmitting component to the second reflecting prism, and the second reflecting prism reflects a reflected light received from the first reflective prism into an optical circulator component.

4. The single-fiber bidirectional optical transceiver module according to claim 3, characterized in that, the first reflective prism includes a first reflective film surface and a second reflective film surface;
the second reflective prism is disposed at a right rear of the first reflective prism, and the second reflective prism includes a third reflective film surface; and
the emitted light emitted from the optical transmitting component is sequentially reflected by the first reflective film surface and the second reflective film surface, then emitted to the second reflective prism, and the emitted light is emitted into circulator component after being reflected by the third reflective film.

5. The single-fiber bidirectional optical transceiver module according to claim 4, characterized in that, the circulator component includes a fourth reflective film surface, and the emitted light is reflected to the fourth reflective film surface through the third reflective film surface, then is emitted to a left after being reflected by the fourth reflective film surface.

6. The single-fiber bidirectional optical transceiver module according to claim 5, characterized in that, the first reflective film surface and the third reflective film surface are arranged parallel to each other, and the second reflective film surface and the fourth reflective film surface are arranged parallel to each other.

7. The single-fiber bidirectional optical transceiver module according to claim 5, characterized in that, an included angle between the first reflective film surface and the second reflective film surface is 90°, and an included angle between the third reflective film surface and the fourth reflective film surfaces is 90°.

8. The single-fiber bidirectional optical transceiver module according to claim 1, characterized in that, the optical transmitting component includes a wavelength division multiplexer, the optical receiving component includes a wavelength demultiplexer and a photodetector, the wavelength division multiplexer is arranged on a left front of the wave demultiplexer, and the photodetector is arranged at a right of the wave demultiplexer.

9. The single-fiber bidirectional optical transceiver module according to claim 8, characterized in that, the optical transmitting component further includes a laser component, and the laser component includes a substrate disposed on the carrier board, and a plurality of lasers and collimating lenses disposed on the substrate;
the laser component is arranged at a right of the wavelength division multiplexer, and a light emitted by the laser enters the wavelength division multiplexer through the collimating lenses; and
a rightmost end of the laser component is aligned with a rightmost end of the wavelength demultiplexer in a left-right direction.

10. The single-fiber bidirectional optical transceiver module according to claim 1, characterized in that, the single-fiber bidirectional optical transceiver module further includes a circuit board fixed on the carrier board, and the circuit board is disposed on a right side of the optical transmitting component and the optical receiving component.
